(19) United States
(12) Patent Application Publication
(10) Pub. No.: US 2026/0253520 A1
(43) Pub. Date: Aug. 27, 2026

(54) ROTARY RENDERING APPARATUS FOR GENERATING PATTERNS IN SOLID PARTICLES

(71) Applicant: Beijing Zhirun Technology Co., Ltd., Beijing (CN)

(72) Inventor: Zhi ZHUANG, Beijing (CN)

(21) Appl. No.: 19/646,425

(22) Filed: Apr. 13, 2026

Related U.S. Application Data
(63) Continuation-in-part of application No. 19/073,430, filed on Mar. 7, 2025.

(30) Foreign Application Priority Data
Mar. 7, 2024 (CN) 202420433928.8

(51) Int. Cl. G09F 9/37

(52) U.S. Cl. CPC G09F 9/375

(57) ABSTRACT

A rotary rendering apparatus for generating patterns in solid particles, including: a base and a carrier. The base has a first rotation axis; the carrier is connected to the base and configured to carry the solid particles and a first magnetic component. A first rotating component has a second rotation axis. The first rotating component is connected to the base and is rotatable about the first rotation axis. A second rotating component is provided with a second magnetic component and configured to magnetically attract the first magnetic component, the second rotating component is connected to the first rotating component and is rotatable about the second rotation axis. A driving assembly is connected to the firs rotating component and the second rotating component, to drive the first rotating component to rotate about the first rotation axis and drive the second rotating component to rotate about the second rotation axis.

### CROSS-REFERENCE TO RELATED APPLICATIONS

This application is a continuation in part application of publication number US2025/0281847, filed March 7, 2025, which claims priority to Chinese patent application No. 202420433928.8, filed on March 07, 2024. The contents of these applications are incorporated herein by reference in their entirety.

### TECHNICAL FIELD

The present disclosure relates to the technical field of rotary rendering apparatus, in particular to a rotary rendering apparatus for generating patterns in solid particles.

### BACKGROUND

A rendering apparatus for generating dynamic patterns in solid particles is commonly applied in scenarios such as decorative displays, interactive entertainment, teaching demonstrations and the like. The rotary rendering apparatus mainly drives solid particles, magnetic media and the like to form dynamic visual patterns, thereby realizing interesting and diversified pattern display effects.

At present, most related rendering apparatuses for generating dynamic patterns in solid particles adopt a single rotational structure that guides a magnet to move on the solid particles through magnetic attraction cooperation, thereby leaving motion trajectories on the solid particles that combine to form patterns. However, due to the limitation of the single rotational structure, the overall motion form and display effect thereof are relatively restricted; composite rotational trajectories cannot be formed, the motion form of the magnetic attraction cooperation is singular, the variation in the motion states of the solid particles and the magnetic attraction component is insufficient, and the generated dynamic pattern effect is monotonous and weak in layering sense.

### SUMMARY

In order to overcome the deficiencies of the prior art, the present disclosure provides a rotary rendering apparatus for generating patterns in solid particles. The rotary rendering apparatus is capable of forming complex and variable continuous motion trajectories, breaks through the limitation of the conventional single rotational trajectory, and greatly enriches the morphology and ornamental value of dynamic patterns.

To realize the above objective, the present disclosure provides a rotary rendering apparatus for generating patterns in solid particles, including:

a base and a carrier; the base is provided with a first rotation axis, the carrier is connected to the base, and the carrier is configured to carry the solid particles and a first magnetic component;

a first rotating component is provided with a second rotation axis;

the first rotating component is connected to the base, the first rotating component is rotatable about the first rotation axis, and the first rotation axis and the second rotation axis are arranged non-coaxially;

a second rotating component is provided with a second magnetic component;

the second magnetic component is configured to magnetically attract and cooperate with the first magnetic component, the second rotating component is connected to the first rotating component, and the second rotating component is rotatable about the second rotation axis;

a driving assembly connected to the first rotating component and the second rotating component;

the driving assembly is configured to drive the first rotating component to rotate about the first rotation axis and drive the second rotating component to rotate about the second rotation axis.

The beneficial effects of the present disclosure are as follows: through the arrangement of the above structures, a rotary rendering apparatus for generating patterns in solid particles by means of dual-axis non-coaxial eccentric rotation in non-contact magnetic attraction linkage is provided. The rotary rendering apparatus effectively solves the problems existing in conventional rendering apparatuses for generating patterns in solid particles. Namely, singular motion form, monotonous dynamic pattern effect, easy wear and jamming of rigid transmission structures, and insufficient operational stability. The driving assembly respectively drives the first rotating component to rotate about the first rotation axis and drives the second rotating component to rotate about the second rotation axis. The two-stage rotational motions are superimposed upon each other, so that the solid particles on the carrier can form complex and variable continuous motion trajectories such as petal-shaped, spiral-shaped, wave-shaped and the like. Thereby breaking through the limitation of the conventional single rotational trajectory and greatly enriching the morphology and ornamental value of dynamic patterns. The second magnetic component on the second rotating component and the first magnetic component on the carrier adopt non-contact magnetic attraction cooperation, which can effectively eliminate wear that may be caused by mechanical friction and can also effectively avoid the problem of jamming.

### BRIEF DESCRIPTION OF DRAWINGS

In order to more clearly illustrate the technical solutions in the embodiments of the present disclosure, the drawings required for use in the description of the embodiments will be briefly introduced below. The drawings in the following description are merely some embodiments of the present disclosure. For a person of ordinary skill in the art, other drawings may also be obtained on the basis of these drawings without involving any inventive labor.

The present disclosure will be further described below in conjunction with the drawings and the embodiments.

FIG. 1 is a schematic structural diagram from one angle of a rotary rendering apparatus according to a first embodiment of the present disclosure.

FIG. 2 is a schematic structural diagram from another angle of the rotary rendering apparatus according to the first embodiment of the present disclosure.

FIG. 3 is a cross-sectional view from another angle of the rotary rendering apparatus according to the first embodiment of the present disclosure.

FIG. 4 is a partial exploded structural diagram from one angle of the rotary rendering apparatus according to the first embodiment of the present disclosure.

FIG. 5 is a partial exploded structural diagram from another angle of the rotary rendering apparatus according to the first embodiment of the present disclosure.

FIG. 6 is a partial structural diagram of the rotary rendering apparatus according to the first embodiment of the present disclosure.

FIG. 7 is an enlarged view of an area encircled by circle A in FIG. 6.

FIG. 8 is a schematic structural diagram from one angle of a rendering apparatus of according to a second embodiment of the present disclosure.

FIG. 9 is a partial structural diagram of the rotary rendering apparatus according to the second embodiment of the present disclosure.

FIG. 10 is a rotational structural diagram of the rotary rendering apparatus according to the first embodiment of the present disclosure.

FIG. 11 is a rotational structural diagram of the rotary rendering apparatus according to the second embodiment of the present disclosure.

### Description of the reference numerals:

1 base, β first rotation axis, 12 first supporting component, 13 transparent cover, 14 second supporting component, 15 first photoelectric limiting component, 16 fixed disk, 161 first limiting component, 2 carrier, 3 first rotating component, α second rotation axis, 32 third end, 321 second circular hole, 33 fourth end, 34 second photoelectric limiting component, 35 first triggering portion, 4 second rotating component, 41 second magnetic component, 42 first end, 421 first circular hole, 43 second end, 431 second magnetic slot, 44 second limiting component, 45 second triggering portion, 5 driving assembly, 51 first driving component, 511 first drive motor, 512 first driving wheel, 513 first driven wheel, 514 first transmission belt, 52 second driving component, 521 second drive motor, 522 second driving wheel, 523 second driven wheel, 524 second transmission belt, 6 first magnetic component, 7 rotation boundary.

### DETAILED DESCRIPTION OF THE EMBODIMENTS

In order to make the above-mentioned objectives, features and advantages of the present disclosure more apparent and easily understandable, the specific embodiments of the present disclosure are described in detail below with reference to the accompanying drawings. In the following description, numerous specific details are set forth in order to provide a thorough understanding of the present disclosure. However, the present disclosure may be implemented in many other ways different from those described herein, and a person skilled in the art may make similar improvements without departing from the spirit of the present disclosure; therefore, the present disclosure is not limited by the specific embodiments disclosed below.

In the description of the present disclosure, it is to be understood that whenever the terms “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “facing the first direction”, “facing the second direction”, “axial”, “radial”, “circumferential” and the like appear, the orientation or positional relationship indicated by these terms is based on the orientation or positional relationship shown in the accompanying drawings, which is merely for the convenience of describing the present disclosure and simplifying the description, and does not indicate or imply that the referred-to device or element must have a specific orientation, be constructed and operated in a specific orientation; therefore, these terms cannot be construed as limiting the present disclosure.

Furthermore, whenever the terms “first” and “second” appear, these terms are used only for descriptive purposes and cannot be understood as indicating or implying relative importance or implicitly specifying the number of the indicated technical features. Accordingly, a feature defined as “first” or “second” may explicitly or implicitly include at least one of the features. In the description of the present disclosure, whenever the term “plurality” appears, the meaning of “plurality” is at least two, for example two, three, etc., unless otherwise explicitly and specifically limited.

In the present disclosure, unless otherwise explicitly specified and defined, whenever the terms “install”, “connect”, “couple”, “fix” and the like appear, these terms shall be understood in a broad sense. For example, the connection may be a fixed connection, a detachable connection, or an integral connection; it may be a mechanical connection or an electrical connection; it may be a direct connection or an indirect connection through an intermediate medium; it may be internal communication between two elements or an interaction relationship between two elements, unless otherwise explicitly limited. For a person of ordinary skill in the art, the specific meaning of the above terms in the present disclosure can be understood according to specific circumstances.

In the present disclosure, unless otherwise explicitly specified and defined, whenever a description such as the first feature being “on” or “under” the second feature or similar descriptions appears, the meaning thereof may be that the first and second features are in direct contact, or that the first and second features are in indirect contact through an intermediate medium. Moreover, the first feature being “above”, “over” and “on” the second feature may mean that the first feature is directly above or obliquely above the second feature, or merely indicates that the horizontal height of the first feature is higher than that of the second feature. The first feature being “below”, “under” and “beneath” the second feature may mean that the first feature is directly below or obliquely below the second feature, or merely indicates that the horizontal height of the first feature is lower than that of the second feature.

### Embodiment 1

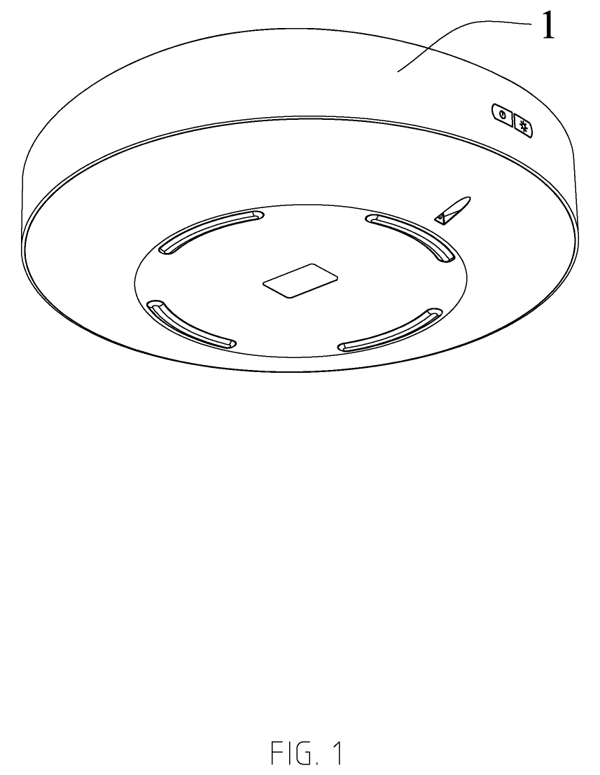

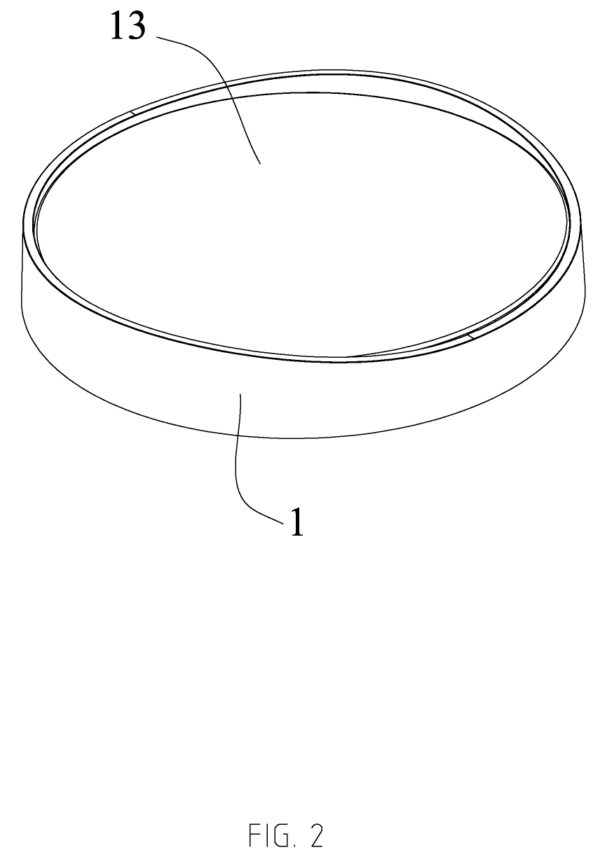

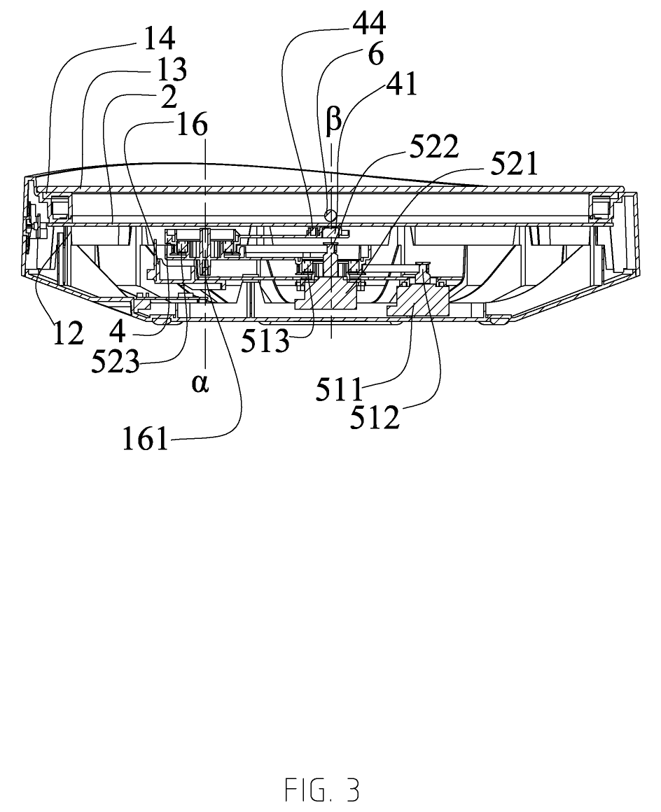

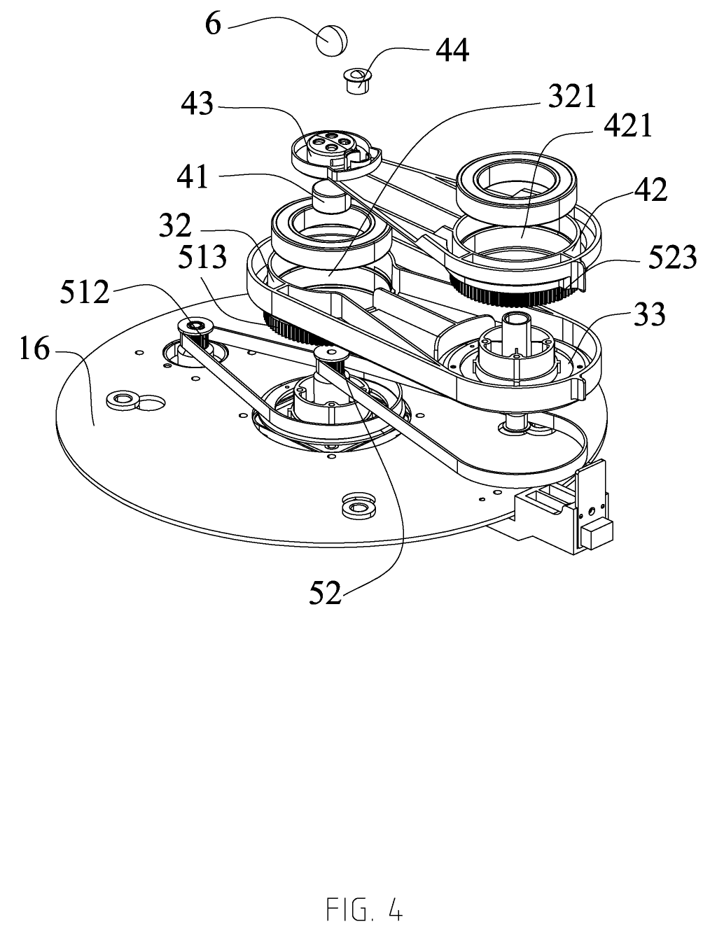

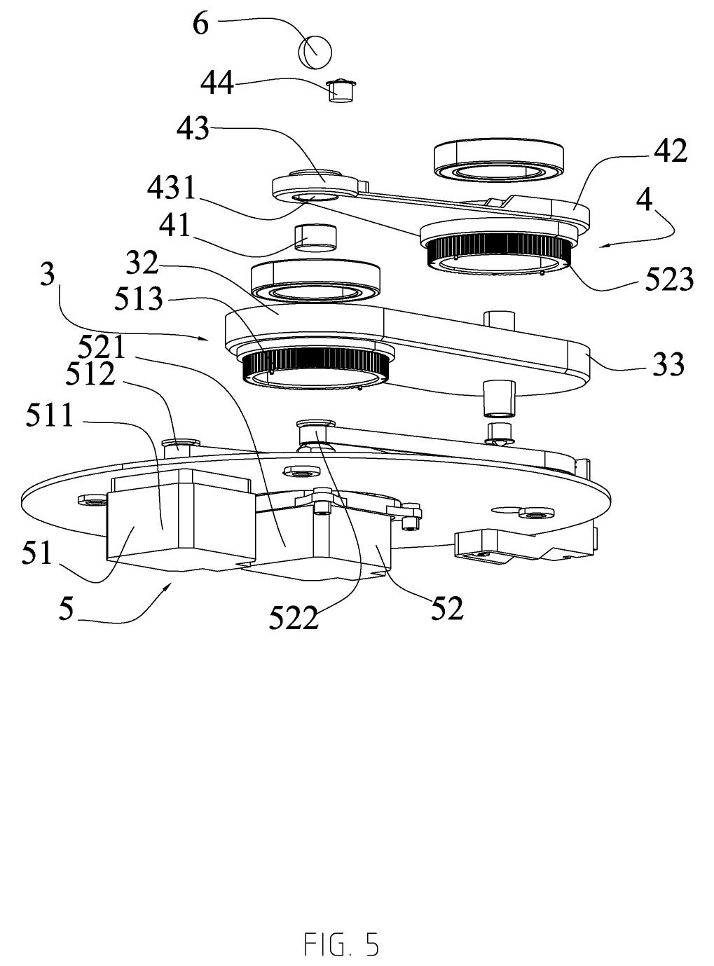

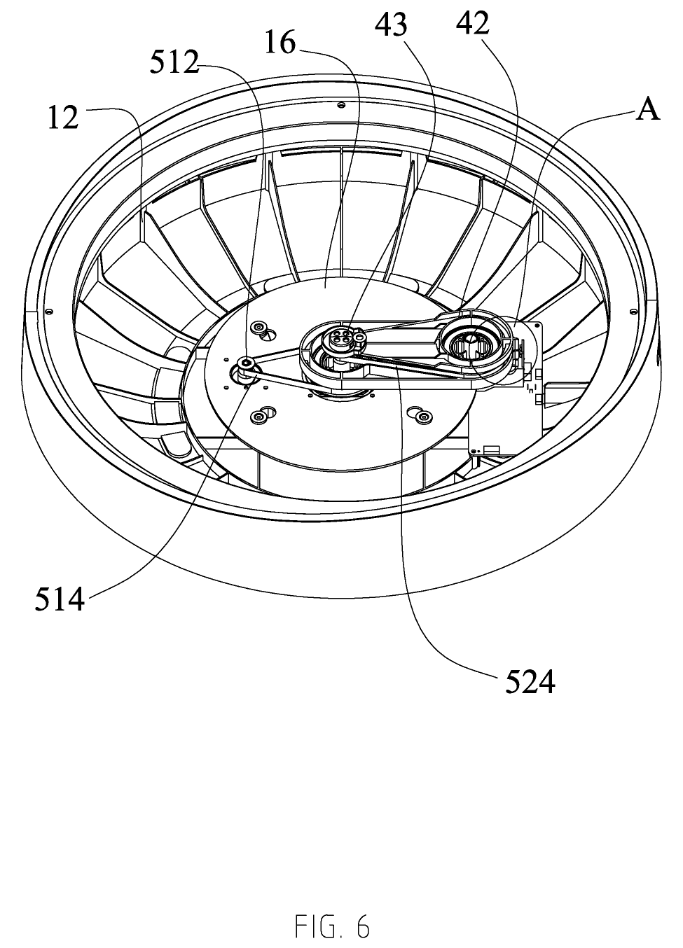

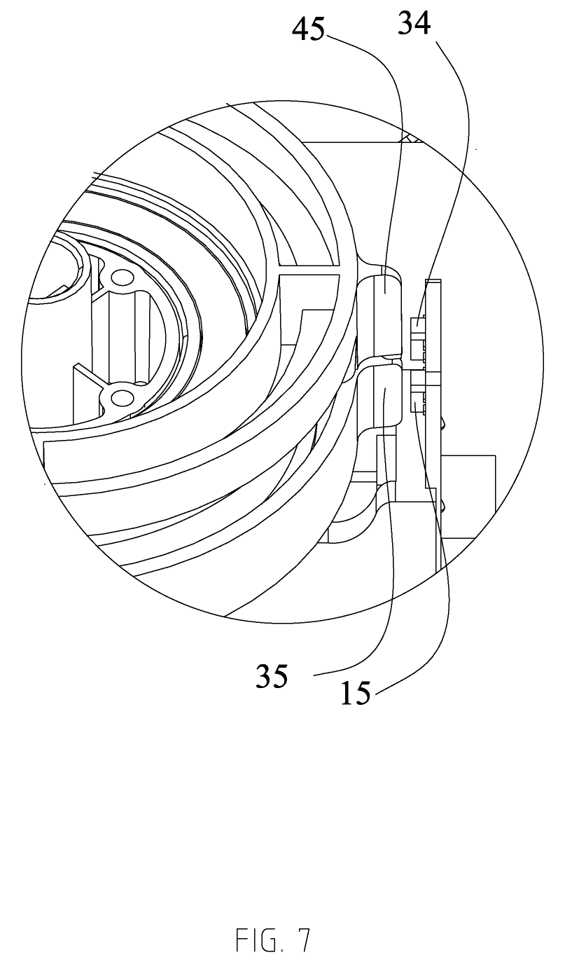

Referring to FIG. 1 to FIG. 7 and FIG. 10, a rotary rendering apparatus for generating patterns in solid particles includes the following components: a base 1 and a carrier 2. The base 1 is provided with a first rotation axis β, the carrier 2 is connected to the base 1, and the carrier 2 is configured to carry the solid particles and a first magnetic component 6.

A first rotating component 3 is provided with a second rotation axis α. The first rotating component 3 is connected to the base 1 and is rotatable about the first rotation axis β, and the first rotation axis β and the second rotation axis α are arranged non-coaxially.

A second rotating component 4 is provided with a second magnetic component 41. The second magnetic component 41 is configured to magnetically attract and cooperate with the first magnetic component 6, the second rotating component 4 is connected to the first rotating component 3 and rotatable about the second rotation axis α.

A driving assembly 5 is connected to the first rotating component 3 and the second rotating component 4. The driving assembly 5 is configured to drive the first rotating component 3 to rotate about the first rotation axis β and drive the second rotating component 4 to rotate about the second rotation axis α.

Through the arrangement of the above structure, a dual-axis non-coaxial eccentric rotation and non-contact magnetic attraction linkage rotary rendering apparatus for generating patterns in solid particles is provided, which effectively solves the problems existing in conventional rotary rendering apparatus for generating patterns in solid particles, namely, a single motion form, a monotonous dynamic pattern effect, easy wear and jamming of rigid transmission structures, and insufficient operational stability.

The driving assembly 5 drives the first rotating component 3 to rotate about the first rotation axis β and drives the second rotating component 4 to rotate about the second rotation axis α. The two-stage rotational motions are superimposed on each other, so that the solid particles on the carrier 2 can form complex and variable continuous motion trajectories such as petal-shaped, spiral-shaped, wave-shaped and the like, breaking through the limitation of the conventional single rotation trajectory and greatly enriching the morphology and ornamental value of the dynamic patterns. The second magnetic component 41 on the second rotating component 4 and the first magnetic component 6 on the carrier 2 adopt non-contact magnetic attraction cooperation, which can effectively eliminate wear possibly caused by mechanical friction and can also effectively avoid the jamming problem.

It should be noted that the first rotation axis β and the second rotation axis α may be either physical entities or virtual axes referring to certain positions on the base 1 and the first rotating component 3.

It should be noted that the first rotating component 3 being rotatable about the first rotation axis β may mean that the first rotating component 3 can self-rotate about the first rotation axis β, or may mean that the first rotating component 3 can co-rotate about the first rotation axis β. The second rotating component 4 being rotatable about the second rotation axis α may mean that the second rotating component 4 can self-rotate about the second rotation axis α, or may mean that the second rotating component 4 can co-rotate about the second rotation axis α.

It should be noted that the rotary rendering apparatus for generating patterns in solid particles of the present disclosure includes but is not limited to a sand painting machine.

It should be noted that the solid particles include but are not limited to sand, plastic particles, ceramic particles and mineral particles.

Specifically, in this embodiment, the first rotating component 3 is configured to rotate about a first rotation axis β, and the second rotating component 4 is configured to rotate about a second rotation axis α. The first rotating component 3 and the second rotating component 4 are enabled to achieve rotational motion within a shorter period of time, thereby improving the generation efficiency of dynamic patterns and the motion response speed, and ensuring that solid particles within the carrier 2 can rapidly follow the composite motion of dual-axis rotation so as to promptly form complex rotating patterns such as petal-shaped patterns and spiral patterns, thereby avoiding problems of pattern generation delay and trajectory discontinuity.

Meanwhile, the independent dual-axis rotation further enhances the coordination of the two-stage rotational motions, such that the movement trajectories of the solid particles are more precise and smoother. Thereby effectively improving the visual effect and stability of the rotating patterns generated by the device, while taking into account both operational efficiency and user experience.

Specifically, when the rotary rendering apparatus for generating rotating patterns in solid particles according to the present disclosure is in use, it is first necessary to place the solid particles and the first magnetic component 6 on the carrier 2. Subsequently, the user activates the driving assembly 5, the driving assembly 5 drives the first rotating component 3 and the second rotating component 4 to rotate. The second magnetic component 41 is in magnetic attraction engagement with the first magnetic component 6, such that the first magnetic component 6 moves across the solid particles in accordance with the motion of the second magnetic component 41, thereby forming a pattern on the solid particles.

In this embodiment, the second rotating component 4 is a second rotating arm, the second rotating arm includes a first end 42 and a second end 43 remote from the first end 42. The second magnetic component 41 is located at the second end 43, the first end 42 is connected to the first rotating component 3, and the second rotating arm is capable of self-rotating about the second rotation axis α.

When the rotary rendering apparatus is located in the return-to-position state, the second rotating arm positions the second end 43 proximate to the first rotation axis β, and the second rotating arm is parallel to the straight line formed by the projection of the first rotation axis β and the second rotation axis α onto the same plane. Thereby effectively reducing the accommodated volume of the rotary rendering apparatus for generating rotating patterns in solid particles according to the present disclosure when in the return-to-position state. The second rotating arm is also capable of cooperating with the first rotating component 3 to achieve a larger range of relative motion and to render the motion trajectory of the second magnetic component 41 more extended and more variable, so as to drive the second magnetic component 41 to move across the solid particles and generate more diversified patterns. Thereby effectively improving the user’s experience and enhancing the practicality of the rotating rendering apparatus for generating patterns in solid particles according to the present disclosure.

Specifically, in this embodiment, the first end 42 is provided with a first circular hole 421. When the first end 42 is connected to the first rotating component 3, the second rotation axis α is located within the first circular hole 421, and a center of the first circular hole 421 is collinear with the second rotation axis α.

Specifically, in this embodiment, the second end 43 is provided with a second magnetic slot 431, and the second magnetic component 41 is located within the second magnetic slot 431. The provision of the second magnetic slot 431 at the second end 43 of the second rotating arm for accommodating the second magnetic component 41 can effectively prevent the second magnetic component 41 from undergoing displacement, loosening, or even detachment during the rotational motion, thereby ensuring that the magnetic attraction engagement position remains stable and accurate at all times. Furthermore, the groove structure is also capable of effectively limiting the circumferential and axial directions of the second magnetic component 41, enhancing motion stability, maintaining the regular external contour of the second end 43, preventing interference or scraping with other components during rotation, and ensuring that the two-stage rotational motions proceed smoothly. Further, the second magnetic slot 431 can also provide a certain protective effect on the second magnetic component 41, reducing the risk of collision and wear thereof and extending its service life.

In other embodiments, the second rotating component 4 is a second rotating disk, the second rotating disk is connected to the first rotating component 3, the second rotation axis α is the rotation center of the rotating disk, the second rotating disk is capable of self-rotating about the second rotation axis α, and the second magnetic component 41 is located at a non-central position of the second rotating disk.

The second rotating disk, which is connected to the first rotating component 3 with its own center serving as the second rotation axis α, enables stable and smooth self-rotation motion. The rotation is steady, the force distribution is uniform, the rotational inertia is more balanced, vibration during operation is smaller, and noise is lower, thereby effectively guaranteeing the stable realization of the magnetic attraction linkage between the second magnetic component 41 and the first magnetic component 6 and preventing transmission failure caused by shaking or offset, resulting in higher motion stability and structural reliability. The disk-type structure is concise and compact, assembly and positioning are convenient, no complex connecting rods or hinged components are required, which is beneficial for simplifying the overall structure, reducing assembly difficulty and production cost, and improving the operational stability and service life of the rotary rendering apparatus.

In this embodiment, the first rotating component 3 is a first rotating arm, the first rotating arm includes a third end 32 and a fourth end 33 remote from the third end 32. The third end 32 is connected to the base 1, the second rotating component 4 is connected to the fourth end 33. The first rotating arm is capable of self-rotating about the first rotation axis β.

The first rotating component 3 is configured as a first rotating arm whose third end 32 is directly connected to the base 1, enabling the first rotating arm to stably complete self-rotation about the first rotation axis β. The fourth end 33 is connected to the second rotating component 4, thereby naturally forming an eccentric arrangement through the extension structure of the rotating arm, allowing the second rotating component 4 to perform circular motion synchronously with the first rotating arm and providing the prerequisite for subsequent superposition with the self-motion of the second rotating component 4 to form complex trajectories. This not only guarantees stable mounting of the second rotating component 4, but also ensures continuous and reliable power transmission. The assembly and positioning of the first rotating arm structure are relatively intuitive, no complex transmission or support components are required. Substantially simplifying the overall structure of the rotary rendering apparatus and reducing production and assembly difficulty. The first-stage self-rotation motion of the first rotating arm, when efficiently superimposed with the motion of the second rotating component 4, can cooperate with the magnetic components to drive the solid particles to move and stack, ultimately forming rich and smooth final patterns such as petals, spirals, and ripples, thereby enhancing the ornamental quality and practicality of the rotary rendering apparatus.

Specifically, in this embodiment, the third end 32 is provided with a second circular hole 321. When the third end 32 is connected to the base 1, the first rotation axis β is located within the second circular hole 321, and the center of the second circular hole 321 is collinear with the first rotation axis β. Through the arrangement of the aforementioned structure, the assembly structure is simplified, alignment installation is facilitated, assembly precision and efficiency are improved. Further, uniform force distribution and stable motion posture of the first rotating component 3 are ensured.

The base 1 further includes a first supporting component 12 whose end distal from the base 1 directly abuts against or is connected to the carrier 2, thereby forming a stable and uniform supporting effect on the carrier 2, avoiding tilting or sagging of the carrier 2 under its own weight and/or magnetic attraction, ensuring that the carrier 2 is always maintained in a reasonable and stable operating position. So that the first magnetic component 6 on the carrier 2 and the second magnetic component 41 on the second rotating component 4 maintain stable magnetic attraction cooperation, thereby preventing magnetic linkage failure and motion transmission interruption that may be caused by positional deviation of the carrier 2. Meanwhile, the first supporting component 12 can effectively disperse the acting force applied to the carrier 2, reduce local stress concentration, improve the structural rigidity and durability of the carrier 2. So that the device is less prone to structural deformation or damage during long-term continuous operation, thereby prolonging the overall service life of the device.

In this embodiment, the driving assembly 5 includes a first driving component 51 and a second driving component 52, the first driving component 51 is connected to the first rotating component 3 and the first driving component 51 drives the first rotating component 3 to rotate about the first rotation axis β, the second driving component 52 is connected to the second rotating component 4, and the second driving component 52 drives the second rotating component 4 to rotate about the second rotation axis α.

The driving assembly 5 is divided into mutually independent first driving component 51 and second driving component 52. The first driving component 51 is independently configured to drive the first rotating component 3 to rotate stably about the first rotation axis β, and the second driving component 52 independently drives the second rotating component 4 to rotate autonomously about the second rotation axis α. The two-stage drives do not interfere with each other and are independently controllable, so that a user can separately adjust the rotation speed, rotation direction, and start/stop state of the corresponding rotating components according to pattern generation requirements. Thereby realizing free combination and dynamic switching of the motions of the first rotating component 3 and the second rotating component 4. Furthermore, the structure of the driving assembly 5 is divided into two independent drive control modules, so that each driving component has a clear division of labor and convenient assembly and positioning, which not only facilitates production assembly and subsequent maintenance but also enables flexible adjustment of drive parameters to adapt to different display scenarios and pattern effect requirements. Thereby further improving the applicability, reliability, and practicality of the device.

In this embodiment, the base 1 is further provided with a transparent cover 13 and a second supporting component 14. An upper end of the second supporting component 14 is configured to support the transparent cover 13 so that the transparent cover 13 covers the carrier 2.

The transparent cover 13 enables unobstructed observation, allowing the exterior to completely and clearly view the various final patterns, such as petal-shaped, spiral-shaped, and wave-shaped patterns, ultimately formed by the internal solid particles under the action of magnetic linkage and two-stage composite rotation. Ensuring that the trajectory presentation is continuous, complete, and with distinct contours, thereby avoiding pattern display blurring or incompleteness that would be caused by opacity of the transparent cover 13 and enhancing the visual effect and artistic expressiveness of the device. The transparent cover 13, which covers the carrier 2, can also effectively protect the carrier 2 from influence by external objects, thereby preventing failure of its function.

In this embodiment, the base 1 is further provided with a first photoelectric limiting component 15. One of the base 1 or the first rotating component 3 is provided with a second photoelectric limiting component 34. The first rotating component 3 is provided with a first triggering portion 35 corresponding to the first photoelectric limiting component 15. The second rotating component 4 is provided with a second triggering portion 45 corresponding to the second photoelectric limiting component 34.

When the first rotating component 3 and the second rotating component 4 rotate, the first triggering portion 35 passes the first photoelectric limiting component 15, and the first photoelectric limiting component 15 records the position of the first rotating component 3 at that moment as the first initial position. The second triggering portion 45 passes the second photoelectric limiting component 34, and the second photoelectric limiting component 34 records the position of the second rotating component 4 at that moment as the second initial position. This effectively solves the problems of disordered solid particle motion trajectories, poor consistency of repeated dynamic motions, and insufficient operational stability in conventional rotary rendering apparatus for generating rotating patterns in solid particles, which arise from the lack of unified initial positioning and inability to unify the return-to-origin position. Moreover, the photoelectric detection method eliminates friction loss caused by mechanical contact, offers fast positioning response and high detection precision. Additionally, without interfering with normal rotation of the first rotating component 3 and the second rotating component 4 or the magnetic linkage, ensures that, upon each startup or operational reset of the device, both stages of rotating components can return to a unified initial position. Thereby keeping the motion superposition relationship of the first rotating component 3 and the second rotating component 4 constant.

Specifically, in this embodiment, the first photoelectric limiting component 15 is located on the base 1, the first triggering portion 35 is located at a side edge of the first rotating component 3, and the second triggering portion 45 is located at a side edge of the second rotating component 4. When the first rotating component 3 is located at the first initial position, the first photoelectric limiting component 15 is positioned outside the first triggering portion 35. When the second rotating component 4 is located at the second initial position, the second photoelectric limiting component 34 is positioned outside the second triggering portion 45.

In this embodiment, the first driving component 51 includes a first drive motor 511, a first driving wheel 512, and a first driven wheel 513. The first drive motor 511 is connected to the base 1, an output shaft of the first drive motor 511 is connected to the first driving wheel 512. The first driving wheel 512 and the first driven wheel 513 are connected through a first transmission belt 514, the first driven wheel 513 is connected to the first rotating component 3. The rotation center of the first driven wheel 513 is the first rotation axis β. The second driving component 52 includes a second drive motor 521, a second driving wheel 522, and a second driven wheel 523. The second drive motor 521 is connected to the base 1 or the first rotating component 3, an output shaft of the second drive motor 521 is connected to the second driving wheel 522. The second driving wheel 522 and the second driven wheel 523 are connected through a second transmission belt 524, the second driven wheel 523 is connected to the second rotating component 4, and the rotation center of the second driven wheel 523 is the second rotation axis α.

With the arrangement of the aforementioned structure, stable power transmission and rotational control can be individually and independently achieved with respect to the first rotating component 3 and the second rotating component 4, respectively. This configuration effectively solves the technical problems inherent in conventional drive structures, namely, high operating noise, susceptibility of the two-stage motions to mutual interference with each other, and insufficient drive precision. Consequently, the drive stability and motion precision of the rendering apparatus — which is configured for generating dynamic patterns with solid particles—are effectively enhanced.

The first driving component 51 adopts a belt-drive configuration in which a first driving motor 511 cooperates with a first driving pulley 512, a first driven pulley 513, and a first transmission belt 514. The first driving motor 511 is connected to the base 1 so as to provide stable power. The first driven pulley 513 is connected to the first rotating component 3 with the first rotation axis β serving as the rotation center, thereby smoothly transmitting power to the first rotating component 3 and ensuring that the first rotating component 3 rotates uniformly and smoothly about the first rotation axis β. In addition, the inherent buffering and vibration-damping characteristics of the belt drive can effectively reduce vibration generated by motor operation, thereby providing a stable driving foundation for the overall composite motion.

The second driving component 52 adopts a pulley-drive structure compatible with that of the first driving component 51. The second driving motor 521 can be flexibly mounted on the base 1 or on the first rotating component 3 so as to adapt to the eccentric rotational layout of the device without generating motion interference with other components. The second driven pulley 523 drives the second rotating component 4 to rotate about its own axis with the second rotation axis α as the center, thereby realizing independent controllability of the two-stage rotational motions. This configuration enables the magnetic-attraction linkage and the motion trajectories of the solid particles to be continuous and smooth, thereby further enhancing the operational reliability, display effect, and practical value of the rotary rendering apparatus of the present disclosure for generating patterns in solid particles.

In the present embodiment, the second rotating component 4 is provided with a second limiting component 44, and only the second limiting component 44 on the second rotating component 4 is connected to or abuts against the surface of the carrier 2 on the side thereof adjacent to the second rotating component 4.

Through the arrangement of the above-described structure, the magnetic-attraction cooperation between the first magnetic component 6 and the second magnetic component 41 causes the second end 43 to move toward the carrier. By forming a mating configuration between the second rotating component 4 and the carrier 2 in which contact occurs solely through the second limiting component 44 while a large area remains suspended and clear, friction resistance, scraping, jamming, and motion interference arising from large-area contact can be effectively avoided. Thereby improving the operational smoothness and structural reliability of the rotary rendering apparatus of the present disclosure for generating patterns in solid particles. The magnetic-attraction gap between the first magnetic component 6 and the second magnetic component 41 is maintained stable and motion transmission remains reliable. Moreover, the structure does not affect the magnetic transmission effect or the formation of the motion trajectory of the solid particles. Under the premise of ensuring structural stability, the mating relationship is simplified, the smoothness of device operation and service life are improved, the overall motion becomes more stable, and pattern display becomes more stable and clear.

Specifically, in the present embodiment, the base 1 is provided with a fixing disk 16, the first rotating component 3 is connected to the fixing disk 16, the driving assembly 5 is connected to the fixing disk 16, and the first rotation axis β is located on the fixing disk 16. Through the arrangement of the above-described structure, the fixing disk 16 provides a unified and stable mounting foundation for both the first rotating component 3 and the driving assembly 5, thereby realizing modular connection of the two with the base 1, making the positioning of the first rotation axis β more precise, and ensuring the coaxiality and motion stability of the first rotating component 3 when it rotates about the first rotation axis β.

Specifically, in the present embodiment, the second limiting component 44 is a universal ball, and the universal ball abuts against the surface of the carrier 2 on the side thereof adjacent to the second rotating component 4.

Through the arrangement of the above-described structure, while stably supporting and limiting the carrier 2, the conventional sliding contact is converted into rolling contact, thereby greatly reducing frictional resistance and wear between the second limiting component 44 and the carrier 2 and effectively preventing motion jamming, increased noise, and component scratching that would otherwise result from excessive friction. The universal ball can adaptively follow changes in the posture of the surface of the carrier 2, thereby always maintaining a stable and reliable abutting state. The universal ball not only provides effective support for the carrier 2, preventing tilting, sagging, or deviation thereof and thereby ensuring stability of the magnetic-attraction cooperation gap, but also does not interfere with the rotational motion of the second rotating component 4, making the two-stage rotational motions smoother and more stable.

In the present embodiment, when the end of the second rotating component 4 remote from the second rotation axis α is at the maximum distance from the second rotation axis α, the end of the second rotating component 4 remote from the second rotation axis α lies within the outer-contour edge of the base 1.

The overall outer contour of the rotary rendering apparatus of the present disclosure for generating patterns in solid particles always remains regular, and no rotating component protrudes beyond the boundary of the base 1 during motion. Consequently, the overall occupied space of the device is reduced, which facilitates storage, transportation, and installation and renders the device particularly suitable for display and use environments having limited space. And, scraping or collision of the second rotating component 4 with external objects during rotation is avoided, thereby preventing deformation or damage to components, significantly improving safety and reliability during operation of the device, and extending service life.

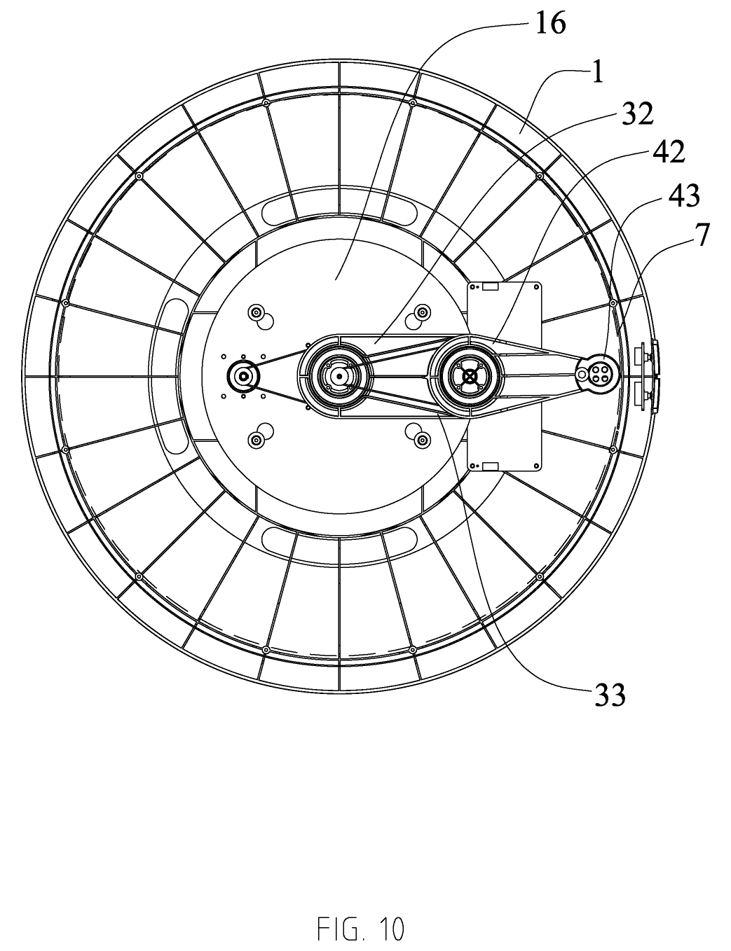

Specifically, in the present embodiment, as shown in FIG. 10, through cooperation of the first rotating component 3 and the second rotating component 4, the second magnetic component 41 can be located at any position within the rotation boundary 7.

### Embodiment 2

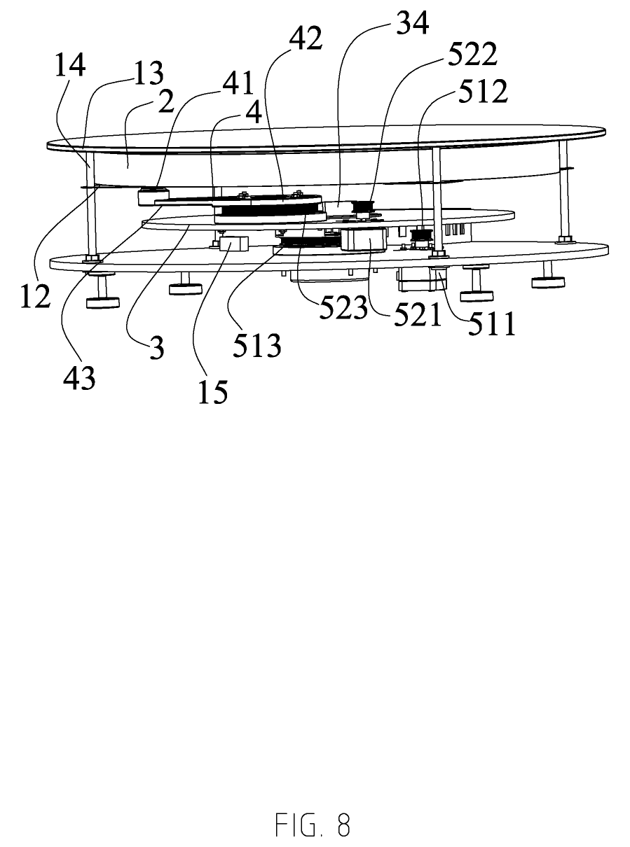

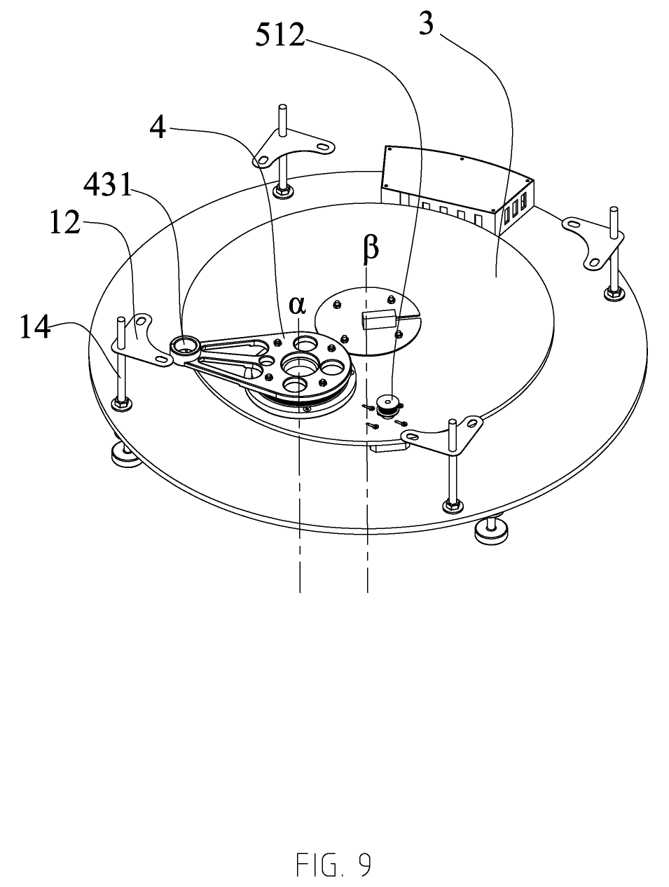

Referring to FIGS. 8, 9 and 11, the rotary rendering apparatus for generating patterns in solid particles provided in the embodiment 2 has the same basic structure, principle and technical effects as those of the first embodiment. For the sake of brevity in description, portions of the embodiment 2 that are not mentioned may be understood with reference to the corresponding contents of the embodiment 1.

In this embodiment, the first rotating component 3 is a first rotating disk, the first rotating disk is connected to the base 1. The first rotation axis β is the rotation center of the rotating disk, and the first rotating disk is capable of self-rotating about the first rotation axis β.

Through the arrangement of the above-described structure, the first rotating component 3 adopts a first rotating disk, taking its own rotation center as the first rotation axis β, thereby enabling stable self-rotation about the first rotation axis β to serve as the primary rotational drive device of the rotary rendering apparatus. The rotating disk-type structure features uniform force distribution and smooth rotation, which can effectively reduce shaking and vibration during the self-rotation process, provide a stable and reliable mounting platform for the second rotating disk, and ensure the fundamental stability of the overall motion. The rotating disk-type structure is simple and compact, convenient for assembly and positioning, and requires no complex connecting rods or hinged components, thereby facilitating simplification of the overall structure, reduction of assembly difficulty and production costs, and improvement of the operational stability and service life of the rotary rendering apparatus.

Specifically, in this embodiment, the second rotation axis α and the first rotation axis β are virtual axes.

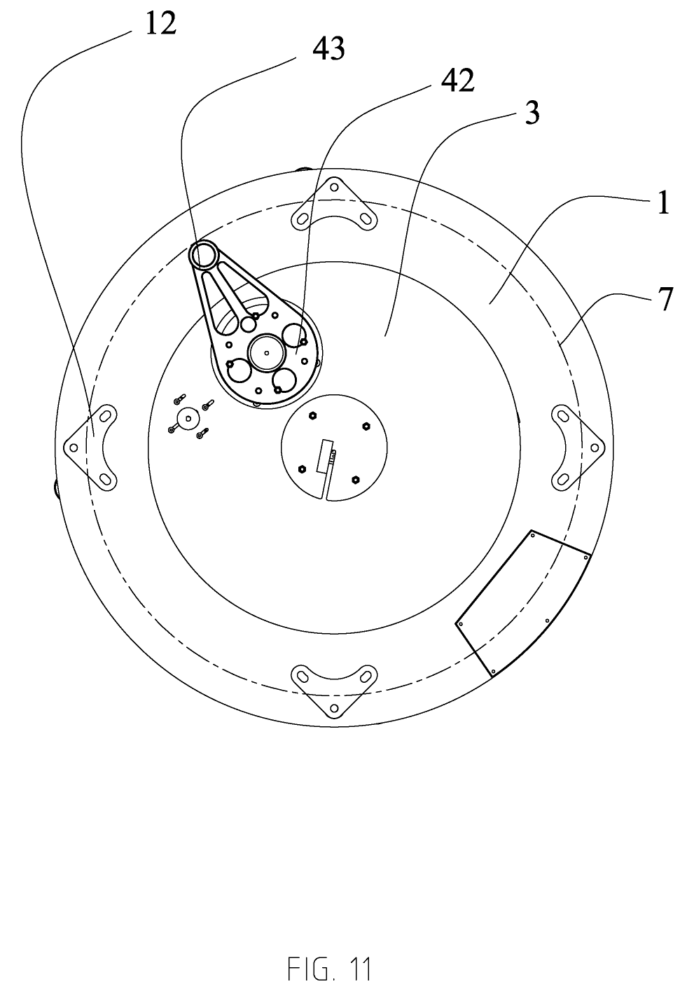

Specifically, in the present embodiment, as shown in FIG. 11, through the cooperation between the first rotating component 3 and the second rotating component 4, the second magnetic component 41 can be positioned at any arbitrary location within the rotation boundary 7.

The foregoing description, provided in conjunction with specific contents, constitutes one or more embodiments of the present disclosure and does not imply that the specific implementations of the present disclosure are limited solely to these descriptions. Any approximations, similarities or equivalents to the methods, structures and the like of the present disclosure, or any technical deductions, modifications or substitutions made on the premise of the inventive concept of the present disclosure, shall be deemed to fall within the protection scope of the present disclosure.

What is claimed is:

1. A rotary rendering apparatus for generating patterns in solid particles, comprising:
a base and a carrier; wherein the base is provided with a first rotation axis, the carrier is connected to the base, and the carrier is configured to carry the solid particles and a first magnetic component;
a first rotating component is provided with a second rotation axis;
wherein the first rotating component is connected to the base, the first rotating component is rotatable about the first rotation axis, and the first rotation axis and the second rotation axis are arranged non-coaxially;
a second rotating component is provided with a second magnetic component;
wherein the second magnetic component is configured to magnetically attract and cooperate with the first magnetic component, the second rotating component is connected to the first rotating component, and the second rotating component is rotatable about the second rotation axis;
a driving assembly connected to the first rotating component and the second rotating component;
wherein the driving assembly is configured to drive the first rotating component to rotate about the first rotation axis and drive the second rotating component to rotate about the second rotation axis.

2. The rotary rendering apparatus for generating patterns in solid particles of claim 1, wherein the second rotating component is self-rotated about the second rotation axis.

3. The rotary rendering apparatus for generating patterns in solid particles of claim 1, wherein the first rotating component is self-rotated about the first rotation axis.

4. The rotary rendering apparatus for generating patterns in solid particles of claim 1, wherein the second rotating component is a second rotating arm;
wherein the second rotating arm comprises a first end and a second end distal from the first end;
wherein the second magnetic component is located at the second end, the first end is connected to the first rotating component, and the second rotating arm is rotatable about the second rotation axis.

5. The rotary rendering apparatus for generating patterns in solid particles of claim 1, wherein the second rotating component is a second rotating disk connected to the first rotating component;
wherein the second rotation axis is a rotation center of the rotating disk, the second rotating disk is rotatable about the second rotation axis; and
the second magnetic component is located at a non-central position of the second rotating disk.

6. The rotary rendering apparatus for generating patterns in solid particles of claim 1, wherein the first rotating component is a first rotating arm, the first rotating arm comprises a third end and a fourth end distal from the third end;
wherein the third end is connected to the base, the second rotating component is connected to the fourth end, and the first rotating arm is rotatable about the first rotation axis.

7. The rotary rendering apparatus for generating patterns in solid particles of claim 1, wherein the first rotating component is a first rotating disk connected to the base;
wherein the first rotation axis is a rotation center of the first rotating disk, and the first rotating disk is rotatable about the first rotation axis.

8. The rotary rendering apparatus for generating patterns in solid particles of claim 1, wherein the base is provided with a first supporting component;
wherein one end of the first supporting component distal from the base abuts against or is connected to the carrier; and
the first supporting component is configured to support the carrier.

9. The rotary rendering apparatus for generating patterns in solid particles of claim 1, wherein the driving assembly comprises a first driving component and a second driving component;
wherein the first driving component is connected to the first rotating component and configured to drive the first rotating component to rotate about the first rotation axis; and
the second driving component is connected to the second rotating component and configured to drive the second rotating component to rotate about the second rotation axis.

10. The rotary rendering apparatus for generating patterns in solid particles of claim 1, wherein the base is further provided with a transparent cover and a second supporting component;
wherein an upper end of the second supporting component is configured to support the transparent cover; and
the transparent cover is configured to cover the carrier.

11. The rotary rendering apparatus for generating patterns in solid particles of claim 1, wherein the base is further provided with a first photoelectric limiting component;
wherein one of the base and the first rotating component is provided with a second photoelectric limiting component;
the first rotating component is provided with a first triggering portion corresponding to the first photoelectric limiting component; and
the second rotating component is provided with a second triggering portion corresponding to the second photoelectric limiting component.

12. The rotary rendering apparatus for generating patterns in solid particles of claim 1, wherein the second rotating component is provided with a second limiting component;
on the second rotating component. only the second limiting component is connected to or abuts against a surface of the carrier on a side close to the second rotating component.

13. The rotary rendering apparatus for generating patterns in solid particles of claim 12, wherein the second limiting component as a universal ball, and the universal ball is abutted against the surface of the carrier on the side close to the second rotating component.

14. The rotary rendering apparatus for generating patterns in solid particles of claim 1, wherein an end of the second rotating component distal from the second rotation axis, when at a maximum distance from the second rotation axis, is located within an outer contour edge of the base.

15. The rotary rendering apparatus for generating patterns in solid particles of claim 1, wherein the first driving component comprises a first drive motor, a first driving wheel and a first driven wheel;
wherein the first drive motor is connected to the base, an output shaft of the first drive motor is connected to the first driving wheel;
the first driving wheel and the first driven wheel are connected through a first transmission belt, and the first driven wheel is connected to the first rotating component, such that a rotation center of the first driven wheel is the first rotation axis;
wherein the second driving component comprises a second drive motor, a second driving wheel and a second driven wheel;
wherein the second drive motor is mounted on the first rotating component, an output shaft of the second drive motor is connected to the second driving wheel;
the second driving wheel and the second driven wheel are connected through a second transmission belt, the second driven wheel is connected to the second rotating component, such that a rotation center of the second driven wheel is the second rotation axis.
